(19) United States
(12) Patent Application Publication
(10) Pub. No.: US 2020/0396718 A1
(43) Pub. Date: Dec. 17, 2020

(54) SIDELINK OPERATION MODES

(71) Applicant: QUALCOMM Incorporated, San Diego, CA (US)

(72) Inventors: Tao LUO, San Diego, CA (US); Sony AKKARAKARAN, Poway, CA (US); Jung Ho RYU, Fort Lee, NJ (US); Junyi LI, Chester, NJ (US)

(21) Appl. No.: 16/899,528

(22) Filed: Jun. 11, 2020

Related U.S. Application Data
(60) Provisional application No. 62/860,731, filed on Jun. 12, 2019.

(51) Int. Cl. H04W 72/02; H04L 5/14; H04L 5/16; H04W 72/04; H04W 8/24

(52) U.S. Cl. CPC H04W 72/02; H04L 5/1469; H04L 5/16; H04W 92/18; H04W 72/0446; H04W 72/0453; H04W 8/24; H04W 72/046

(57) ABSTRACT

Certain aspects of the present disclosure provide techniques for sidelink operation modes. A method that may be performed by a user equipment (UE) includes determining at least one of: time, frequency, or spatial resources for communicating via one or more access links, one or more sidelinks, or both, based on at least one operating mode configured for the communications. The method includes communicating via the one or more access links, one or more sidelinks, or both using the determined resources.

### CROSS-REFERENCE TO RELATED APPLICATION(S)

This application claims benefit of and priority to U.S. Provisional Application No. 62/860,731, filed Jun. 12, 2019, which is hereby assigned to the assignee hereof and hereby expressly incorporated by reference herein in its entirety as if fully set forth below and for all applicable purposes.

### BACKGROUND

### Field of the Disclosure

Aspects of the present disclosure relate to wireless communications, and more particularly, to techniques for sidelink operation modes.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved sidelink communications.

Certain aspects provide a method for wireless communication. The method generally includes determining at least one of: time, frequency, or spatial resources for communicating via one or more access links, one or more sidelinks, or both, based on at least one operating mode configured for the communications. The method includes communicating via the one or more access links, one or more sidelinks, or both using the determined resources.

Certain aspects provide a method for wireless communication. The method generally includes determining at least one operating mode for a user equipment (UE) to communicate via one or more access links, one or more sidelinks, or both. The method includes configuring the UE with the determined at least one operating mode.

Certain aspects provide an apparatus for wireless communication. The apparatus generally includes at least one processor and a memory coupled to the at least one processor. The memory generally includes code executable by the at least one processor to cause the apparatus to determine at least one of: time, frequency, or spatial resources for communicating via one or more access links, one or more sidelinks, or both, based on at least one operating mode configured for the communications. The memory generally includes code executable by the at least one processor to cause the apparatus to communicate via the one or more access links, one or more sidelinks, or both using the determined resources.

Certain aspects provide an apparatus for wireless communication. The apparatus generally includes at least one processor and a memory coupled to the at least one processor. The memory generally includes code executable by the at least one processor to cause the apparatus to determine at least one operating mode for a UE to communicate via one or more access links, one or more sidelinks, or both. The memory generally includes code executable by the at least one processor to cause the apparatus to configure the UE with the determined at least one operating mode.

Certain aspects provide an apparatus for wireless communication. The apparatus generally includes means for determining at least one of: time, frequency, or spatial resources for communicating via one or more access links, one or more sidelinks, or both, based on at least one operating mode configured for the communications. The apparatus includes means for communicating via the one or more access links, one or more sidelinks, or both using the determined resources.

Certain aspects provide an apparatus for wireless communication. The apparatus generally includes means for determining at least one operating mode for a UE to communicate via one or more access links, one or more sidelinks, or both. The apparatus includes means for configuring the UE with the determined at least one operating mode.

Certain aspects provide a computer readable medium storing computer executable code thereon for wireless communication. The computer executable code generally includes code for determining at least one of: time, frequency, or spatial resources for communicating via one or more access links, one or more sidelinks, or both, based on at least one operating mode configured for the communications. The computer executable code includes code for communicating via the one or more access links, one or more sidelinks, or both using the determined resources.

Certain aspects provide a computer readable medium storing computer executable code thereon for wireless communication. The computer executable code generally includes code for determining at least one operating mode for a UE to communicate via one or more access links, one or more sidelinks, or both. The computer executable code includes code for configuring the UE with the determined at least one operating mode.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example BS and UE, in accordance with certain aspects of the present disclosure.

FIG. 3 is an example frame format for certain wireless communication systems (e.g., new radio (NR)), in accordance with certain aspects of the present disclosure.

FIG. 4A and FIG. 4B show diagrammatic representations of example vehicle to everything (V2X) systems, in accordance with certain aspects of the present disclosure.

FIG. 5 is a flow diagram illustrating example operations for wireless communication by a user equipment (UE), in accordance with certain aspects of the present disclosure.

FIG. 6 is a call flow diagram illustrating example time division multiplexed (TDMed) access link and sidelink communications, in accordance with aspects of the present disclosure.

FIG. 7 is a call flow diagram illustrating example TDMed sidelink and sidelink communications, in accordance with aspects of the present disclosure.

FIG. 8 is a call flow diagram illustrating example TDMed access link and multiple sidelink communications, in accordance with aspects of the present disclosure.

FIG. 9 is a call flow diagram illustrating example time division duplexed (TDD) full duplex access link and sidelink communications, in accordance with aspects of the present disclosure.

FIG. 10 is a call flow diagram illustrating example TDD full duplex sidelink and sidelink communications, in accordance with aspects of the present disclosure.

FIG. 11 is a call flow diagram illustrating example TDD half-duplex access link and sidelink communications, in accordance with aspects of the present disclosure.

FIG. 12 is a flow diagram illustrating example operations for wireless communication by a user equipment (UE), in accordance with certain aspects of the present disclosure.

FIG. 13 illustrates a communications device that may include various components configured to perform operations for the techniques disclosed herein in accordance with aspects of the present disclosure.

FIG. 14 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for sidelink operation modes.

In sidelink, a sidelink device such as a user equipment (UE) may communicate with another sidelink device (e.g., another UE) via a sidelink, such as via PC5. The sidelink device may communicate with multiple sidelink devices. The sidelink device may communicate a base station (BS) via an access link.

In some cases, communications via the access and sidelink may be time division multiplexed (TDMed). In this case, the sidelink device communicates with the BS using different time resources than the sidelink device uses to communicate via the sidelink. Similarly, sidelinks may be TDMed. In this case, the sidelink device communicates with different sidelink devices using different time resources.

Some UEs may have multiple antennas panels and may be capable of full duplex operation. With full duplex operation, the sidelink device can both transmit and receive simultaneously. Thus, the sidelink device may be able to communicate via the access link and/or via multiple sidelinks using the same time resources with spatial division multiplexing (SDM) and/or frequency division multiplexing (FDM). For example, using different panels and/beams the sidelink device can transmit and receive using different spatial resources, with the same time and frequency resources for SDM. With FDM, the sidelink device can use different frequency resources for transmitting and receiving. Using different panel and beams and/or frequency resources, the sidelink device can communicate via the access link using one panel, while communicating with multiple sidelinks using SDM, FDM, and/or TDD. With a subband full duplex, the sidelink device can simultaneously transmit and receive using different frequency resources (e.g., with a single carrier partitioned into subblocks), while for full band full duplex, the sidelink device can simultaneously transmit and receive on the same of time frequency resources.

The following description provides examples of sidelink operations modes in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

The techniques described herein may be used for the wireless networks and radio technologies mentioned above as well as other wireless networks and radio technologies. For clarity, while aspects may be described herein using terminology commonly associated with 3G, 4G, and/or 5G wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

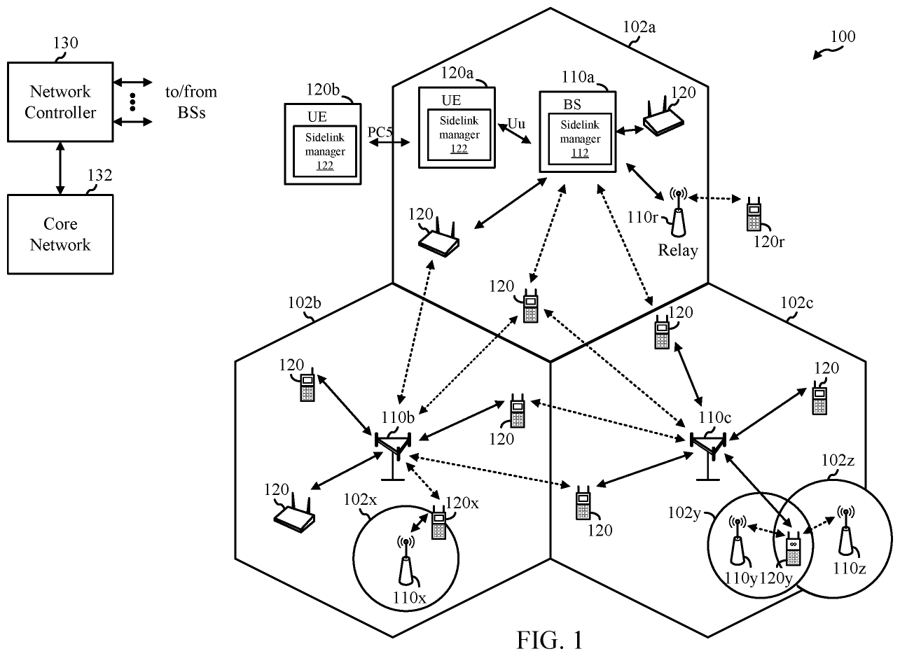

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110110a-z (each also individually referred to herein as BS 110 or collectively as BSs 110) and/or user equipment (UE) 120a-y (each also individually referred to herein as UE 120 or collectively as UEs 120) in the wireless communication network 100 via one or more interfaces.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

According to certain aspects, the BSs 110 and UEs 120 may be configured for sidelink communications. As shown in FIG. 1, the UE 120a includes a sidelink manager 122a, the BS 110a includes a sidelink manager 112a, and the sidelink UE 120b includes a sidelink manager 122b. The sidelink manager 122a, sidelink manager 112a, and sidelink manager 122b may be configured for sidelink operation modes, in accordance with aspects of the disclosure. For example, the UE 120a may communicate simultaneously with the BS 110a, the sidelink UE 120b, and/or one or more other sidelink UEs 120 using one or more of the sidelink operations modes.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

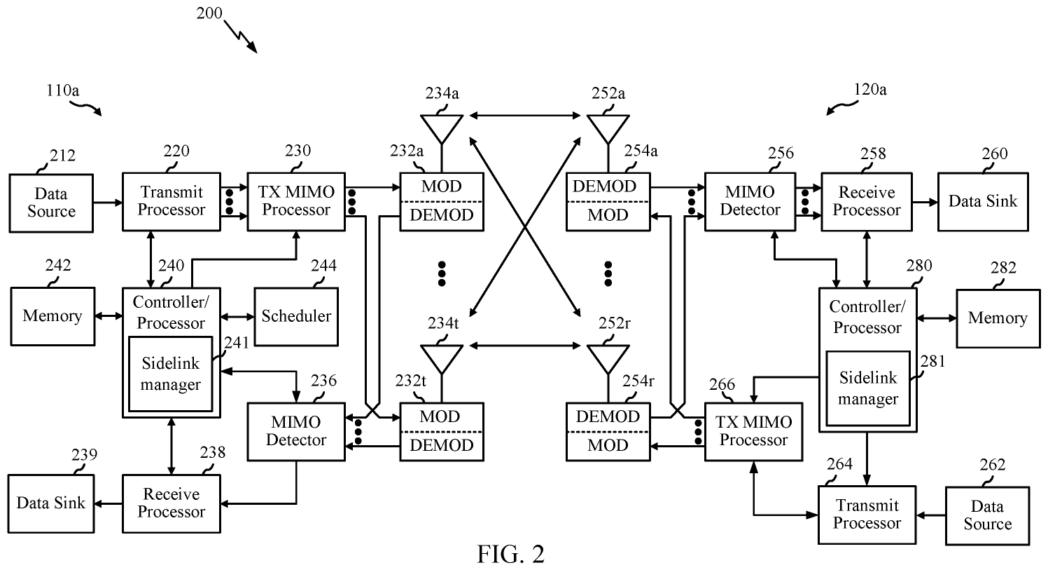

FIG. 2 illustrates example components of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), PDCCH, group common PDCCH (GC PDCCH), etc. The data may be for the PDSCH, etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 280 of the UE 120a has a sidelink manager 282 that may be configured for sidelink operation modes, according to aspects described herein. Although shown at the controller/processor, 280 other components of the UE 120a may be used performing the operations described herein. The controller/processor 240 of the BS 110a has a sidelink manager 242 that may be configured for sidelink operation modes, according to aspects described herein. Although shown at the controller/processor, 240 other components of the BS 110a may be used performing the operations described herein. NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

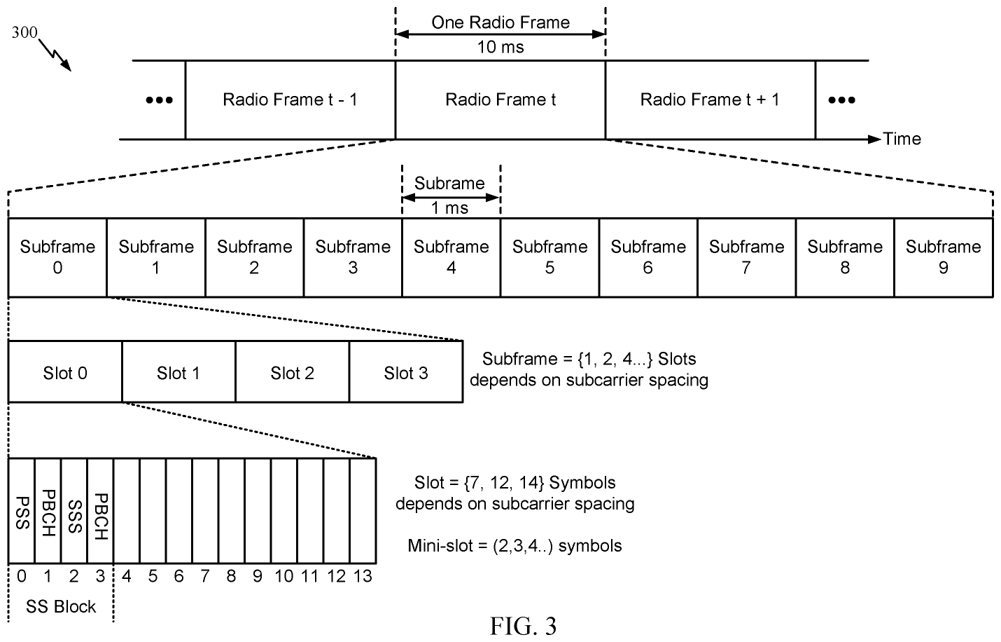

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In some examples, the communication between the UEs 120 and BSs 110 is referred to as the access link. The access link may be provided via a Uu interface. Communication between devices may be referred as the sidelink.

In some examples, two or more subordinate entities (e.g., UEs 120) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE 120a) to another subordinate entity (e.g., another UE 120) without relaying that communication through the scheduling entity (e.g., UE 120 or BS 110), even though the scheduling entity may be utilized for scheduling and/or control purposes. In some examples, the sidelink signals may be communicated using a licensed spectrum (unlike wireless local area networks, which typically use an unlicensed spectrum). One example of sidelink communication is PC5, for example, as used in V2V, LTE, and/or NR.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions. The PSFCH may carry feedback such as CSI related to a sidelink channel quality.

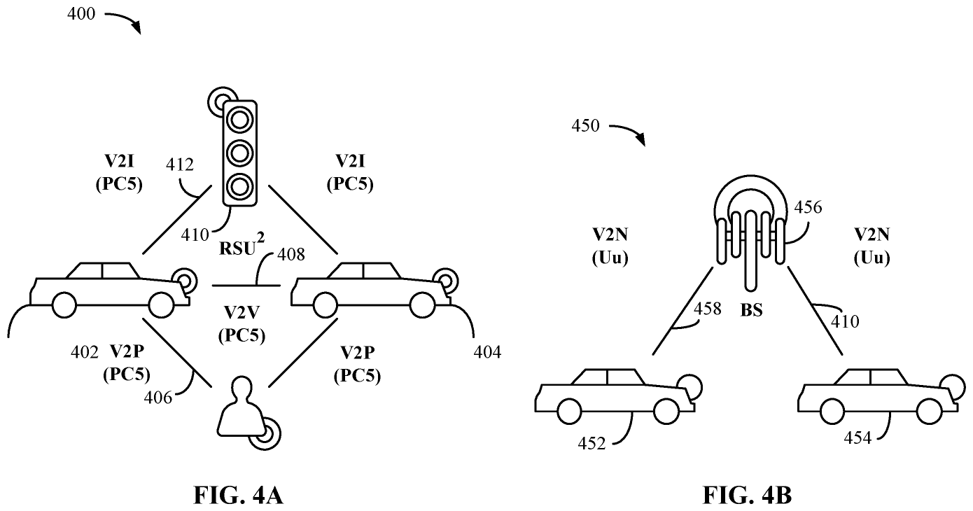

FIG. 4A and FIG. 4B show diagrammatic representations of example V2X systems, in accordance with some aspects of the present disclosure. For example, the vehicles shown in FIG. 4A and FIG. 4B may communicate via sidelink channels and may perform sidelink CSI reporting as described herein.

The V2X systems, provided in FIG. 4A and FIG. 4B provide two complementary transmission modes. A first transmission mode, shown by way of example in FIG. 4A, involves direct communications (for example, also referred to as sidelink communications) between participants in proximity to one another in a local area. A second transmission mode, shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle to vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 410 may be used, for example, for long range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NB-type RSUs have similar functionality as the Macro eNB/gNB. The Micro NB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

### Example Sidelink Operation Modes

Aspects of the present disclosure provide operation modes for sidelink communication.

According to certain aspects, sidelink transmissions may be transmitted with or without additional sidelinks by a user equipment (UE) or by multiple UEs. In addition, sidelink transmissions may be transmitted with or without additional access link transmissions from and/or to a base station (BS). For example, a UE with multiple antenna modules can communicate at the same time (e.g., simultaneously, concurrently, or near simultaneously) via the access and sidelink, via the access link and multiple sidelinks, or via multiple sidelinks.

According to certain aspects, different operations modes, for example with different types of duplexing, may be used for sidelink and/or access link communications between one or more access links and/or one or more sidelinks. As will be discussed in more detail below, a sidelink device may communicate using time division duplexing (TDD) operating modes, time division multiplexing (TDM) operating modes, full-duplex operating modes, half-duplex operating modes, spatial division multiplexing (SDM) operating modes, frequency division multiplexing (FDM) operating modes, full band full duplexing modes, and/or subband full duplexing modes.

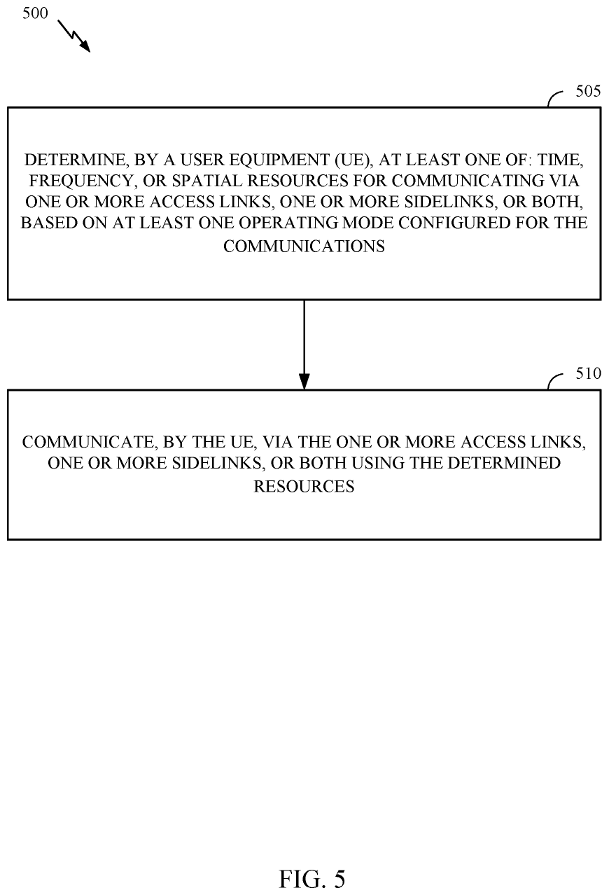

FIG. 5 is a flow diagram illustrating example operations 500 for wireless communication, in accordance with certain aspects of the present disclosure. The operations 500 may be performed, for example, by a UE (e.g., such as a UE 120a in the wireless communication network 100). Operations 500 may be implemented as software components that are executed and run on one or more processors (e.g., controller/processor 280 of FIG. 2). Further, the transmission and reception of signals by the UE in operations 500 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 500 may begin, at 505, by determining at least one of: time, frequency, or spatial resources for communicating via one or more access links, one or more sidelinks, or both, based on at least one operating mode configured for the communications.

In some examples, a TDM operating mode is configured for the one or more access links, one or more sidelinks, or both. The UE may determine different time resources for communicating via access links than for sidelinks. The UE may determine different time resources for communicating via different sidelinks. The UE may determine different time resources for communicating via access links and different sidelinks.

In some examples, a TDD operating mode is configured for the one or more access links, the one or more sidelinks, or both. In some examples, the TDD operating modes uses SDM or FDM. The spatial resources may include UE antenna panels, UE beams, or both. The UE may determine different spatial resources and the same time resources for communicating via the one or more access links, the one or more sidelinks, or both.

The TDD operating mode may be a full-duplex TDD operating mode. In some examples, the full-duplex operating mode may be between an access link and sidelink. The UE may determine a first set of spatial resources and a first set of time resources for transmitting via the one or more access links. The UE may determine a second set of spatial resources, different than the first set of spatial resources, and the first set of time resources for receiving via the one or more sidelinks. The UE may determine a third set of spatial resources and a second set of time resources for receiving via the one or more access links. The UE may determine a fourth set of spatial resources, different than the third set of spatial resources, and the second set of time resources for transmitting via the one or more sidelinks.

In some examples, the full-duplex operating mode may be between multiple sidelinks. The UE may determine a first set of spatial resources and a first set of time resources for transmitting via a first sidelink. The UE may determine a second set of spatial resources, different than the first set of spatial resources, and the first set of time resources for receiving via a second sidelink. The UE may determine a third set of spatial resources and a second set of time resources for receiving via the one or more access links. The UE may determine a fourth set of spatial resources, different than the third set of spatial resources, and the second set of time resources for transmitting via the one or more sidelinks.

The TDD operating mode may be a half-duplex TDD operating mode. The UE may determine a first set of spatial resources and a first set of time resources for transmitting via the one or more access links. The UE may determine a second set of spatial resources, different than the first set of spatial resources, and the first set of time resources for transmitting via the one or more sidelinks. The UE may determine a third set of spatial resources and a second set of time resources for receiving via the one or more access links. The UE may determine a fourth set of spatial resources, different than the third set of spatial resources, and the second set of time resources for receiving via the one or more sidelinks.

The at least one operating mode is configured based on one or more UE capabilities. The one more UE capabilities may include a number of available antenna panels at the UE, a number of available beams at the UE, support for half-duplex operation, support for full duplex operation, support for simultaneous transmissions, support for simultaneous receptions, support simultaneous transmission and reception, supported operating modes, or a combination thereof. The UE may indicate the one or more UE capabilities to a BS.

At 510, the UE communicates via the one or more access links, one or more sidelinks, or both using the determined resources.

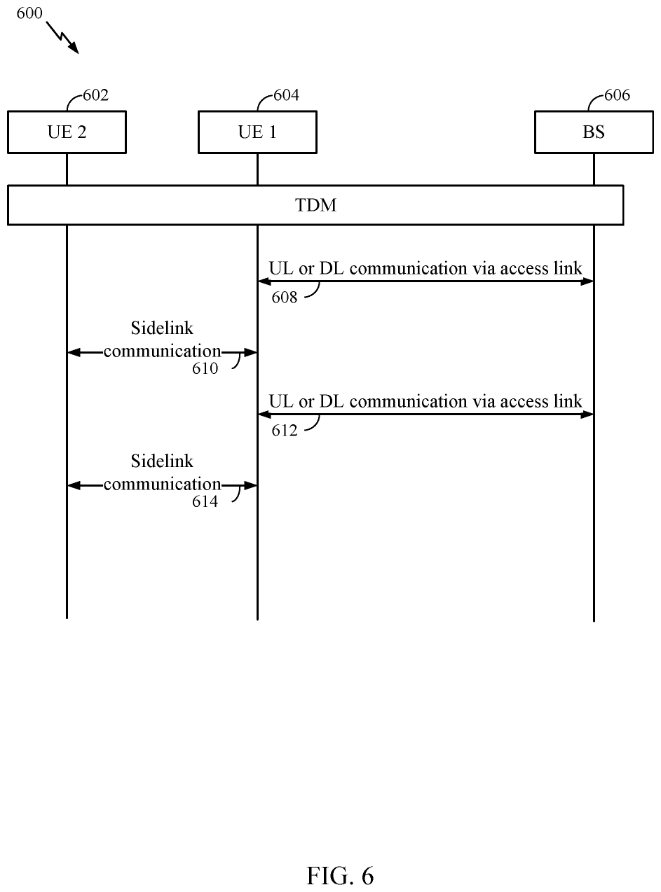

According to certain aspects, access link communications and sidelink communications are TDMed. In this example, a device (e.g., a UE) communicates with a BS via the access link communication in different time periods than the device communicates with another device via the sidelink. This may avoid downlink and/or uplink interference at the device. As shown in an illustrative example in FIG. 6, a UE 604 (UE 1) communicates (uplink or downlink) with the BS 606 via the access link in time periods 608 and 612 and the UE 604 communicates (transmit or receive) with the UE 602 (UE 2) via a sidelink in different time periods 610 and 614.

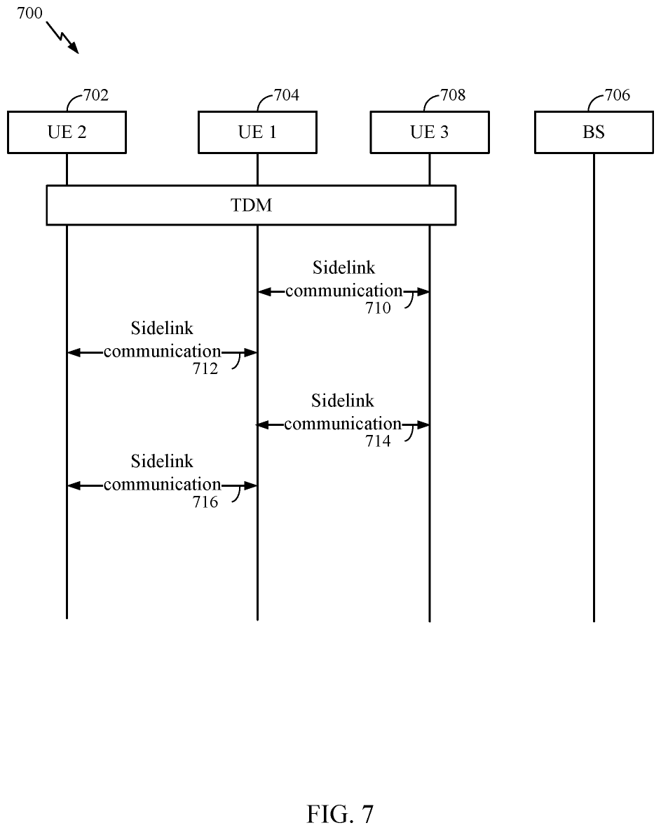

According to certain aspects, sidelink and sidelink are TDMed. In this example, a device (e.g., a UE) may communicate with another device via the sidelink communication in different time periods than the device communicates with yet another device via another sidelink. This may avoid downlink and/or uplink interference at the device. As shown in an illustrative example in FIG. 7, a UE 704 (UE 1) communicates with the UE 708 (UE 3) via a sidelink in time periods 710 and 714 and the UE 704 (UE 1) communicates with the UE 702 (UE 2) via a sidelink in different time periods 712 and 716.

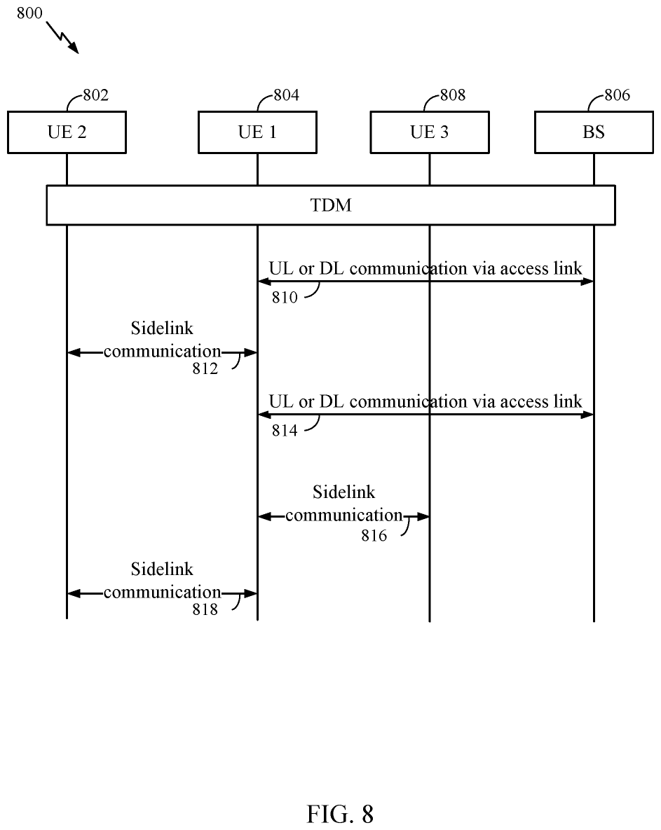

According to certain aspects, the device is TDMed with multiple sidelinks in additional to the access link. As shown in an illustrative example in FIG. 8, a UE 804 (UE 1) communicates with the UE 808 (UE 3) via a sidelink in time period 816; the UE 804 (UE 1) communicates with the UE 802 (UE 2) via a sidelink in different time periods 812 and 818; and the UE 804 (UE 1) communicates (uplink or downlink) with the BS 806 via an access link in further different time periods 810 and 814.

According to certain aspects, sidelink and access link communications and/or sidelink and sidelink communications are flexibly TDD. For example, the communications may be TDD using SDM and/or FDM. A UE having multiple panels may use a combination of UE antenna panels and/or beams for the TDD using SDM and/or FDM.

In some examples, the sidelink and/or access link communications can operate in the TDD operating mode with full duplexing. For sidelink and access link, one UE antenna panel/beam may be used to transmit via the access link and another UE antenna panel/beam may be used to receive via the sidelink at the same time; or one UE antenna panel/beam may be used to receive via the access link and another UE antenna panel/beam may be used to transmit via the sidelink at the same time. In some examples, the UE may SDM and/or FDM to transmit and/or receive from multiple sidelink(s). In some examples, full band full duplexing may be used, in which the UE may transmit or receive simultaneously via the access link and sidelink(s) or via multiple sidelinks, using the same time and frequency resources.

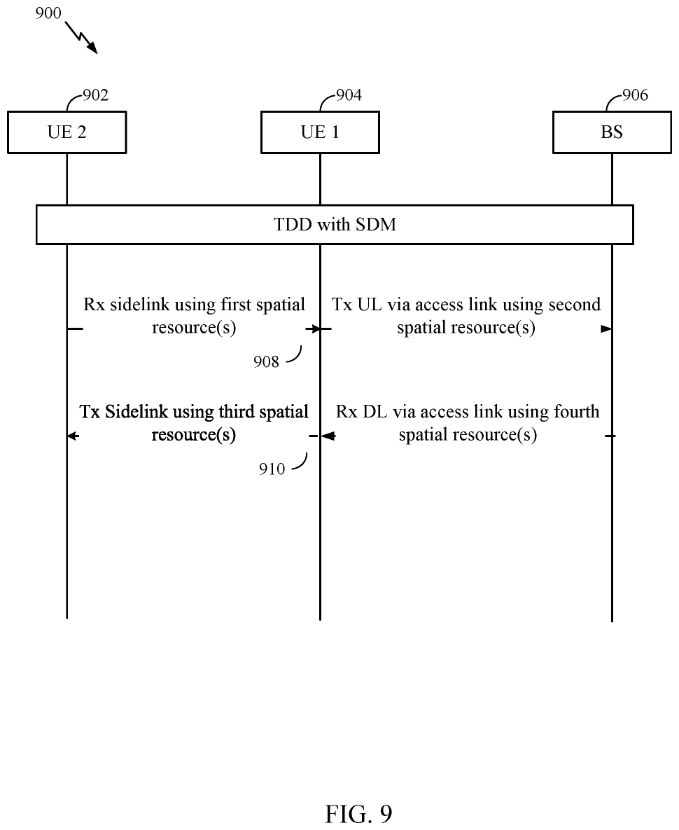

As shown in an illustrative example in FIG. 9, a UE 904 (UE 1) receives from the UE 902 (UE 2) via a sidelink using a first spatial resource(s) (e.g., first UE antenna panel(s)/beam(s)) and at the same time 908 the UE 904 (UE 1) transmits (uplink) to the BS 906 via an access link using second spatial resource(s) (e.g., second UE antenna panel(s)/beam(s)). The first and second spatial resource(s) are different. As shown in an illustrative example in FIG. 9, the UE 904 (UE 1), additionally or alternatively, may transmit to the UE 902 (UE 2) via a sidelink using a third spatial resource(s) (e.g., third UE antenna panel(s)/beam(s)) and at the same time 910 the UE 904 (UE 1) receives (downlink) from the BS 906 via an access link using fourth spatial resource(s) (e.g., fourth UE antenna panel(s)/beam(s)). The third and fourth spatial resource(s) are different from each other, but could be the same or different than the first or second spatial resource(s).

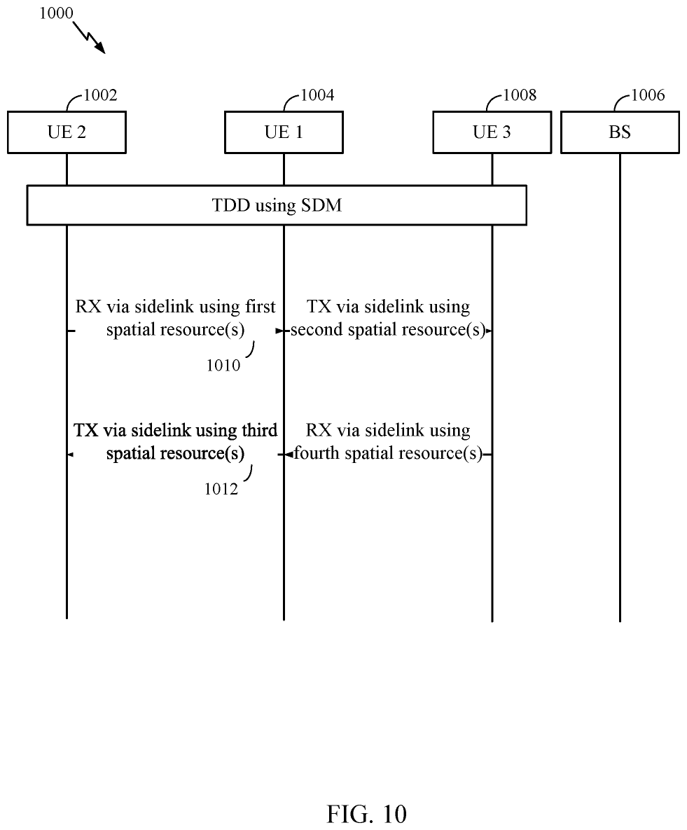

In some examples, the sidelink and sidelink communications can operate in the TDD operating mode with full duplexing. For sidelink and sidelink, one UE antenna panel/beam may be used to transmit via a first sidelink and another UE antenna panel/beam may be used to receive via another sidelink at the same time; or one UE antenna panel/beam may be used to receive via the first sidelink and another UE antenna panel/beam may be used to transmit via the second sidelink at the same time. As shown in an illustrative example in FIG. 10, a UE 1004 (UE 1) receives from the UE 1002 (UE 2) via a sidelink using a first spatial resource(s) (e.g., first UE antenna panel(s)/beam(s)) and at the same time 1010 the UE 1004 (UE 1) transmits to the UE 1008 (UE 3) via a sidelink using second spatial resource(s) (e.g., second UE antenna panel(s)/beam(s)). The first and second spatial resource(s) are different. As shown in an illustrative example in FIG. 10, the UE 704 (UE 1), additionally or alternatively, may transmit to the UE 1002 (UE 2) via a sidelink using a third spatial resource(s) (e.g., third UE antenna panel(s)/beam(s)) and at the same time 1012 the UE 704 (UE 1) receives from the serving UE 1008 (UE 3) via a sidelink using fourth spatial resource(s) (e.g., fourth UE antenna panel(s)/beam(s)). The third and fourth spatial resource(s) are different from each other, but could be the same or different than the first or second spatial resource(s). In some examples, the UE may transmit to another UE via the sidelink using a first UE antenna panel/beam and may receive from the other UE via the sidelink at the same time using a second UE antenna panel/beam.

The access link and one or multiple sidelinks communications can operate with half duplexing. For sidelink and sidelink, one UE antenna panel/beam may be used to receive via a first sidelink and another UE antenna panel/beam may be used to transmit via another sidelink at the same time. The access link and sidelink communications can operate with half duplexing. For example, the UE can transmit on the access link (or links, from one or more BSs) while at the same time the UE receives for one or multiple sidelinks. In some examples, the UE can receive on the access link (or links, from one or more BSs) while at the same time the UE receives for one or multiple sidelinks. As another example, the UE can transmit on the access link (or links, from one or more BSs) while at the same time the UE transmits for one or multiple sidelinks. In some examples, the UE can receive on the access link (or links, from one or more BSs) while at the same time the UE receives for one or multiple sidelinks.

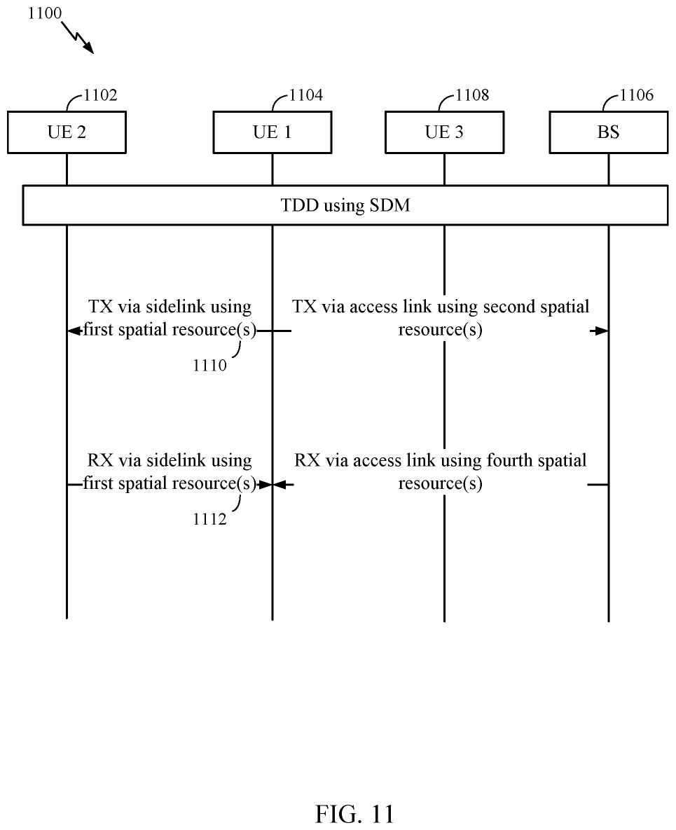

As shown in an illustrative example in FIG. 11, a UE 1104 (UE 1) transmits to the UE 1102 (UE 1) via a sidelink using a first spatial resource(s) (e.g., first UE antenna panel(s)/beam(s)) and at the same time 1110 the UE 104 (UE 1) transmits (uplink) to the BS 1106 via an access link using second spatial resource(s) (e.g., second UE antenna panel(s)/beam(s)). The first and second spatial resource(s) are different. As shown in an illustrative example in FIG. 11, the UE 1104 (UE 1), additionally or alternatively, may receive from the UE 1102 (UE 1) via a sidelink using a first spatial resource(s) (e.g., third UE antenna panel(s)/beam(s)) and at the same time 1112 the UE 1104 (UE 1) receives (downlink) from the BS 1106 via an access link using fourth spatial resource(s) (e.g., fourth UE antenna panel(s)/beam(s)). The third and fourth spatial resource(s) are different from each other, but could be the same or different than the first or second spatial resource(s). In some examples, the UE may transmit to another UE via the sidelink using a first UE antenna panel/beam and may receive from the other UE via the sidelink at the same time using a second UE antenna panel/beam.

Although the various transmit/receive modes (e.g., operating modes) described above are shown with UEs 1-3, a sidelink UE may communicate with greater numbers of UEs. In addition, while the various operating modes described above show half duplex and full duplex TDM and TDD with SDM, operating modes may also include FDM such TDD with FDM or TDD with SDM and FDM.

The various transmit/receive modes (e.g., operating modes) described above may be configured based on the UE's capabilities, such as available number of antenna panels, available number of beams, support for half-duplex operation, full-duplex operation, etc. For example, a UE without any multi-beam capability may only either transmit to one entity or receive from one entity at any given time (i.e., half-duplex, single link). A UE with multi-beam and/or multi-panel capability but without full-duplex capability may not be able to simultaneously transmit and receive, because of imperfect isolation between the transmitter and receiver (causing the receiver to be unable to pick up the intended receive signal due to strong interference from the transmit signal of the same UE), however, the multiple panels/beams may still allow for simultaneous transmission on multiple links (e.g., multiple side-links, multiple access-links, or a combination of side-links and access-links) and likewise for simultaneous reception on multiple links. Further, a UE with partial full-duplex capabilities may be capable of simultaneous transmission and reception subject to certain constraints, such as, for example, that simultaneous transmission and reception both be on side-links, or that transmission be on side-link while reception is on access-link, or vice-versa.

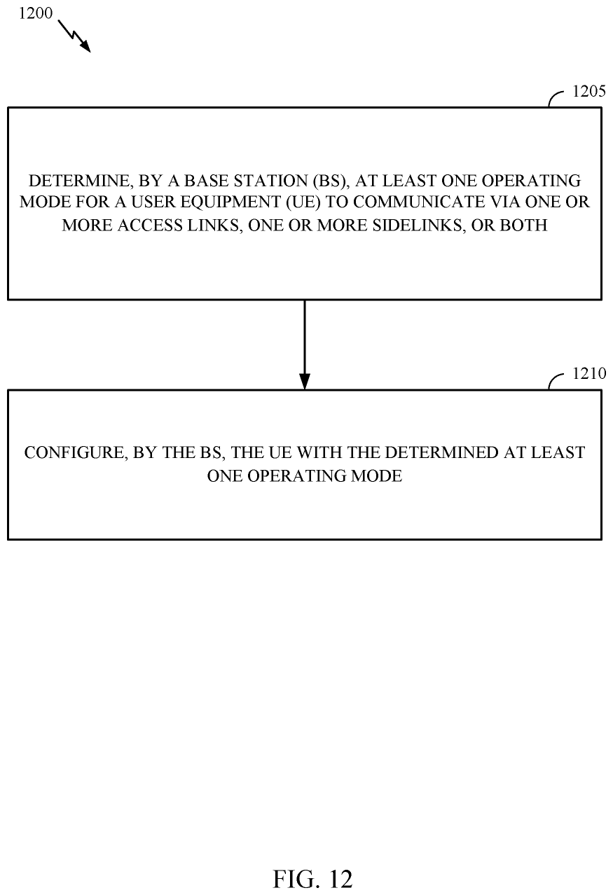

A BS, such as a BS 110 which may be a gNB, may be configured to perform operations for the access link complementary to the UE operations 500. FIG. 12 is a flow diagram illustrating example operations 1200 for wireless communication, in accordance with certain aspects of the present disclosure. The operations 1200 may be performed, for example, by a BS (e.g., such as a BS 110a in the wireless communication network 100). Operations 1200 may be implemented as software components that are executed and run on one or more processors (e.g., controller/processor 240 of FIG. 2). Further, the transmission and reception of signals by the BS in operations 1200 may be enabled, for example, by one or more antennas (e.g., antennas 234 of FIG. 2). In certain aspects, the transmission and/or reception of signals by the UE may be implemented via a bus interface of one or more processors (e.g., controller/processor 240) obtaining and/or outputting signals.

The operations 1200 may begin, at 1205, by determining at least one operating mode for a UE to communicate via one or more access links, one or more sidelinks, or both.

The at least one operating mode is determined based on one or more UE capabilities. For example, the one more UE capabilities may include a number of available antenna panels at the UE, a number of available beams at the UE, support for half-duplex operation, support for full duplex operation, support for simultaneous transmissions, support for simultaneous receptions, support simultaneous transmission and reception, supported operating modes, or a combination thereof. In some examples, the BS receives an indication from the UE of the one or more UE capabilities.

At 1210, the BS configures the UE with the determined at least one operating mode. The BS may configured the UE with a full-duplex TDD operating mode with SDM, FDM, or both is configured for the one or more access links, the one or more sidelinks, or both

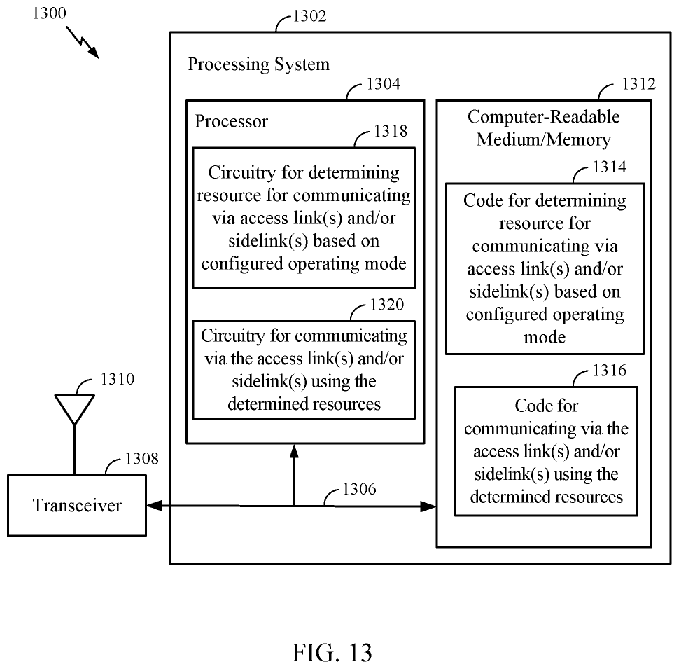

FIG. 13 illustrates a communications device 1300 that may include various components (e.g., corresponding to means-plus-function components) configured to perform operations for the techniques disclosed herein, such as the operations illustrated in FIG. 5. The communications device 1300 includes a processing system 1302 coupled to a transceiver 1308. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 5, or other operations for performing the various techniques discussed herein for sidelink operation modes. In certain aspects, computer-readable medium/memory 1312 stores code 1314 for determining at least one of: time, frequency, or spatial resources for communicating via one or more access links, one or more sidelinks, or both, based on at least one operating mode configured for the communications; and/or code 1316 for communicating via the one or more access links, one or more sidelinks, or both using the determined resources, in accordance with aspects of the disclosure. In certain aspects, the processor 1304 has circuitry configured to implement the code stored in the computer-readable medium/memory 1312. The processor 1304 includes circuitry 1318 for determining at least one of: time, frequency, or spatial resources for communicating via one or more access links, one or more sidelinks, or both, based on at least one operating mode configured for the communications; and/or circuitry 1320 for communicating via the one or more access links, one or more sidelinks, or both using the determined resources, in accordance with aspects of the disclosure.

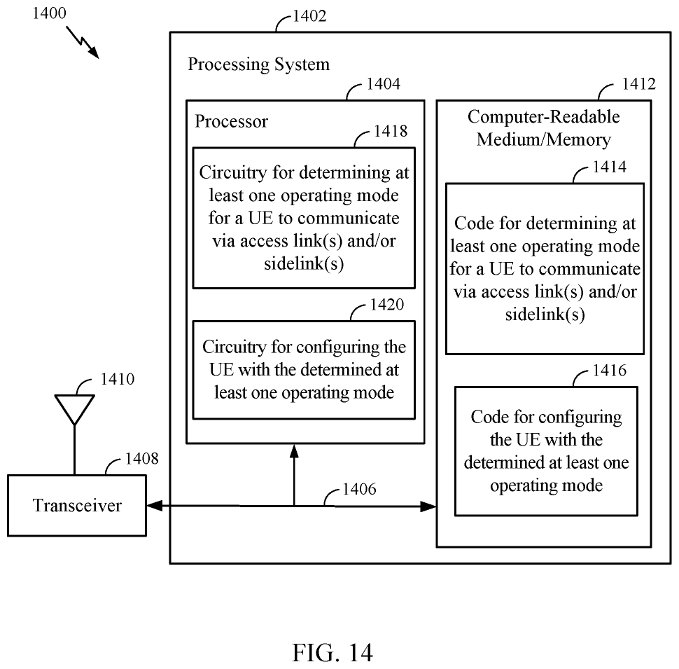

FIG. 14 illustrates a communications device 1400 that may include various components (e.g., corresponding to means-plus-function components) configured to perform operations for the techniques disclosed herein, such as the operations illustrated in FIG. 12. The communications device 1400 includes a processing system 1402 coupled to a transceiver 1408. The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIG. 12, or other operations for performing the various techniques discussed herein for sidelink operation modes. In certain aspects, computer-readable medium/memory 1412 stores code 1414 for determining at least one operating mode for a UE to communicate via one or more access links, one or more sidelinks, or both; and/or code 1416 for configuring the UE with the determined at least one operating mode, in accordance with aspects of the disclosure. In certain aspects, the processor 1404 has circuitry configured to implement the code stored in the computer-readable medium/memory 1412. The processor 1404 includes circuitry 1418 for determining at least one operating mode for a UE to communicate via one or more access links, one or more sidelinks, or both; and/or circuitry 1420 for configuring the UE with the determined at least one operating, in accordance with aspects of the disclosure.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 5-12.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication by a user equipment (UE), comprising:
determining at least one of: time, frequency, or spatial resources for communicating via one or more access links, one or more sidelinks, or both, based on at least one operating mode configured for the communications; and
communicating via the one or more access links, one or more sidelinks, or both using the determined resources.

2. The method of claim 1, wherein the spatial resources comprise UE antenna panels, UE beams, or both.

3. The method of claim 1, wherein:
a time division duplexing (TDD) operating mode is configured for the one or more access links, the one or more sidelinks, or both; and
determining the time resources comprises determining different spatial resources and the same time resources for communicating via the one or more access links, the one or more sidelinks, or both.

4. The method of claim 3, wherein the TDD operating mode comprises a full-duplex TDD operating mode with spatial division multiplexing (SDM), frequency division multiplexing (FDM), or both.

5. The method of claim 3, wherein determining the time and spatial resources comprises:
determining a first set of spatial resources and a first set of time resources for transmitting via the one or more access links; and
determining a second set of spatial resources, different than the first set of spatial resources, and the first set of time resources for receiving via the one or more sidelinks.

6. The method of claim 3, wherein determining the time and spatial resources comprises:
determining a third set of spatial resources and a second set of time resources for receiving via the one or more access links; and
determining a fourth set of spatial resources, different than the third set of spatial resources, and the second set of time resources for transmitting via the one or more sidelinks.

7. The method of claim 3, wherein determining the time and spatial resources comprises:
determining a first set of spatial resources and a first set of time resources for transmitting via a first sidelink; and
determining a second set of spatial resources, different than the first set of spatial resources, and the first set of time resources for receiving via a second sidelink.

8. The method of claim 7, wherein determining the time and spatial resources comprises:
determining a third set of spatial resources and a second set of time resources for receiving via the one or more access links; and
determining a fourth set of spatial resources, different than the third set of spatial resources, and the second set of time resources for transmitting via the one or more sidelinks.

9. The method of claim 3, wherein determining the time and spatial resources comprises:
determining a first set of spatial resources and a first set of time resources for transmitting via the one or more access links; and
determining a second set of spatial resources, different than the first set of spatial resources, and the first set of time resources for transmitting via the one or more sidelinks.

10. The method of claim 3, wherein determining the time and spatial resources comprises:
determining a third set of spatial resources and a second set of time resources for receiving via the one or more access links; and
determining a fourth set of spatial resources, different than the third set of spatial resources, and the second set of time resources for receiving via the one or more sidelinks.

11. The method of claim 1, wherein the at least one operating mode is configured based on one or more UE capabilities.

12. The method of claim 11, wherein the one more UE capabilities comprises a number of available antenna panels at the UE, a number of available beams at the UE, support for half-duplex operation, support for full duplex operation, support for simultaneous transmissions, support for simultaneous receptions, support simultaneous transmission and reception, supported operating modes, or a combination thereof

13. The method of claim 11, further comprising indicating the one or more UE capabilities to a base station (BS).

14. The method of claim 1, wherein a time division multiplexing (TDM) operating mode is configured for the one or more access links, one or more sidelinks, or both.

15. The method of claim 14, wherein determining the time resources comprises determining different time resources for communicating via access links than for sidelinks.

16. The method of claim 14, wherein determining the time resources comprises determining different time resources for communicating via different sidelinks.

17. The method of claim 14, wherein determining the time resources comprises determining different time resources for communicating via access links and different sidelinks.

18. A method for wireless communication by a base station (BS), comprising:
determining at least one operating mode for a user equipment (UE) to communicate via one or more access links, one or more sidelinks, or both; and
configuring the UE with the determined at least one operating mode.

19. The method of claim 18, wherein the at least one operating mode is determined based on one or more UE capabilities.

20. The method of claim 19, wherein the one more UE capabilities comprises a number of available antenna panels at the UE, a number of available beams at the UE, support for half-duplex operation, support for full duplex operation, support for simultaneous transmissions, support for simultaneous receptions, support simultaneous transmission and reception, supported operating modes, or a combination thereof

21. The method of claim 19, further comprising receiving an indication from the UE of the one or more UE capabilities.

22. The method of claim 18, wherein:
a full-duplex time division duplexing (TDD) operating mode with spatial division multiplexing (SDM), frequency division multiplexing (FDM), or both is configured for the one or more access links, the one or more sidelinks, or both.

23. An apparatus for wireless communication, comprising:
at least one processor; and
a memory coupled to the at least one processor, the memory comprising code executable by the at least one processor to cause the apparatus to:
determine at least one of: time, frequency, or spatial resources for communicating via one or more access links, one or more sidelinks, or both, based on at least one operating mode configured for the communications; and
communicate via the one or more access links, one or more sidelinks, or both using the determined resources.

24. The apparatus of claim 23, wherein the spatial resources comprise UE antenna panels, UE beams, or both.

25. The apparatus of claim 23, wherein:
a time division duplexing (TDD) operating mode is configured for the one or more access links, the one or more sidelinks, or both; and
determining the time resources comprises determining different spatial resources and the same time resources for communicating via the one or more access links, the one or more sidelinks, or both.

26. The apparatus of claim 25, wherein the TDD operating mode comprises a full-duplex TDD operating mode with spatial division multiplexing (SDM), frequency division multiplexing (FDM), or both.

27. The apparatus of claim 25, wherein determining the time and spatial resources comprises:
determining a first set of spatial resources and a first set of time resources for transmitting via the one or more access links; and
determining a second set of spatial resources, different than the first set of spatial resources, and the first set of time resources for receiving via the one or more sidelinks.

28. The apparatus of claim 25, wherein determining the time and spatial resources comprises:
determining a third set of spatial resources and a second set of time resources for receiving via the one or more access links; and
determining a fourth set of spatial resources, different than the third set of spatial resources, and the second set of time resources for transmitting via the one or more sidelinks.

29. The apparatus of claim 25, wherein determining the time and spatial resources comprises:
determining a first set of spatial resources and a first set of time resources for transmitting via a first sidelink; and
determining a second set of spatial resources, different than the first set of spatial resources, and the first set of time resources for receiving via a second sidelink.

30. The apparatus of claim 23, wherein the at least one operating mode is configured based on one or more UE capabilities.
